(19) United States
(12) Patent Application Publication
(10) Pub. No.: US 2013/0013510 A1
(43) Pub. Date: Jan. 10, 2013

(54) System, Method, and Apparatus for Creating and Distributing a Transaction Credit

(75) Inventor: Ansar ANSARI, Santa Clara, CA (US)

(73) Assignee: BLACKHAWK NETWORK, INC., Pleasanton, CA (US)

(21) Appl. No.: 13/619,226

(22) Filed: Sep. 14, 2012

Related U.S. Application Data
(63) Continuation of application No. 13/495,986, filed on Jun. 13, 2012.
(60) Provisional application No. 61/496,397, filed on Jun. 13, 2011.
(60) Provisional application No. 61/496,404, filed on Jun. 13, 2011.

(51) Int. Cl. G06Q 20/40

(52) U.S. Cl. 705/44

(57) ABSTRACT

An embodiment(s) of a system(s), method(s), and/or apparatus is presented for accepting requests for, determining approval of, and distributing transaction credit(s) (TC(s)). An embodiment of a system(s), method(s), and/or apparatus is presented for distributing a useable TC to a designated recipient in real time. An embodiment of a system(s), method(s), and/or apparatus is presented for providing a consumer a useable TC in any tangible form that may be known in the art, or that can be transferred via, stored in, or retrieved from an electronic format, or that can be physically fabricated by a consumer or transferee of the TC. An embodiment of a system(s), method(s), and/or apparatus is presented for providing a consumer or transferee of a TC notification of receipt of such a TC through a variety of notification means.

### CROSS-REFERENCE TO RELATED APPLICATION

This application is a continuation of and claims priority to U.S. patent application Ser. No. 13/495,986 filed on Jun. 13, 2012 which claims priority to U.S. Provisional Patent Application Ser. Nos. 61/496,397 and 61/496,404, both filed Jun. 13, 2011 and entitled “System, Method, and Apparatus for Creating and Distributing a Transaction Credit;” each of which is incorporated by reference herein in its entirety.

### BACKGROUND

The “Technical Field” involved relates generally to financial transactions, and particularly to systems, methods, and apparatus for facilitating real-time prepaid transaction credits (TCs).

The related “Background Art” includes systems, methods, and apparatus intended to facilitate financial transactions designed to minimize credit outlays by sellers, and to induce consumer purchase of goods and services. Among such art are cards with prepaid value that a consumer may present for purchase of goods or services, based upon agreements between card issuers or distributors and goods or services sellers. Production, distribution, and security for physical embodiments of cards representing prepaid transaction credit (TC) create costs to producers and distributors of such cards. Consumer opportunity to purchase such cards can be limited by the breadth and efficiency of a distribution process utilizing existing merchant locations. Once purchased, such cards generally require activation before they are negotiable, but once activated, they are commonly useable by anyone in possession of the card. The various systems and methods for card activation require varying amounts of effort and time delay between a consumer's desire to activate a card for use, and an activation that makes a card a negotiable instrument. Traditionally, such card issuers and distributors do not guarantee or insure the value of such cards against loss. Historically, consumers do not redeem up to nineteen percent of such cards purchased.

### BRIEF SUMMARY

In an embodiment, a system for providing at least one transaction credit (TC) is described. The system comprises a reception processor configured to interface with at least one memory unit, the memory unit storing at least one message application capable of receiving an authorized request to create a TC, the reception processor also configured to interface with at least one memory unit storing at least one account application capable of creating or authenticating at least one customer account associated with the request received, wherein the account application is capable of issuing at least one time-limited authorized-client-requested user token capable of facilitating a request validation and of maintaining an end user session. The request may be received through at least one application programming interface (API) enabled to facilitate access, communication, interface, interaction, and/or use of at least one component, function, element and/or aspect, etc. of at least one processor and/or at least one application service and/or resource. The at least one API may, without limiting its composition or functionality, set rules, conventions, and/or specifications for routines, data structures, object classes, and/or protocols, or their like as may be known in the art. The API may facilitate interaction with a user, such as but not limited to, a client or a customer software program. A client may be a partner, associate, or approved party, of the owner, operator, or licensee of the system(s), method(s), and/or apparatus disclosed herein. The system also comprises a decision processor configured to interface with at least one memory unit, the memory unit storing at least one evaluation application for verifying sufficient prepayment or account credit line for requested for TC, determining whether to approve the request for TC, and creating a TC account, which may be associated with a client or customer account. The system also comprises at least one accessible resource encoded in at least one computer-readable medium, the accessible resource configured to interface with any processor or application comprising the method and to store any data, records, images, information, or the like as may need by any processor or application comprising the method. A computer-readable medium may include a single medium or multiple media, such as but not limited to, a centralized or distributed database, and/or associated caches and servers that store one or more sets of data and/or instructions. A computer-readable medium may also include any medium that is capable of storing, encoding or carrying a set of instructions for execution by a processor or application or that cause a computer system to perform any one or more of the methods or operations disclosed herein. The system also comprises a response processor configured to interface with at least one memory unit storing at least one output application for distributing at least one approved TC and/or at least one alternate message, wherein the reception, decision, and response processors are capable of interfacing with each other to coincidentally receive a user request, create a customer account, issue a user token, verify prepayment or credit line for requested transaction credit, determine approval of requested transaction credit, create a transaction credit account, which may be associated with a client and/or customer account, and distribute a transaction credit, and notification of same, and/or at least one alternate message to at least one user or third party.

In an embodiment, a method of providing at least one TC is described. The method comprises receiving a request by a reception processor configured to interface with at least one memory unit, the memory unit storing at least one message application capable of receiving an authorized request to create a TC, the reception processor also configured to interface with at least one memory unit storing at least one account application capable of creating or authenticating at least one customer account associated with the request received, wherein the account application is capable of issuing at least one time-limited authorized-client-requested user token capable of facilitating a request validation and of maintaining an end user session. The request may be received through at least one application programming interface (API) enabled to facilitate access, communication, interface, interaction, and/or use of at least one component, function, element and/or aspect, etc. of at least one processor and/or at least one application, as disclosed herein, service and/or resource. The at least one API may, without limiting its composition or functionality, set rules, conventions, and/or specifications for routines, data structures, object classes, and/or protocols, or their like as may be known in the art. The API may facilitate interaction with a user, such as but not limited to, a client or a customer software program. A client may be a partner, associate, or approved party, of the owner, operator, or licensee of the system(s), method(s), and/or apparatus disclosed herein. The method also comprises determining whether to approve the request for TC, and creating a TC account, which may be associated with a client or customer account, wherein a decision processor is configured to interface with at least one memory unit, the memory unit storing at least one evaluation application for verifying sufficient prepayment or account credit line for requested for TC, determining whether to approve the request for TC. The method also comprises interfacing with an accessible resource encoded in a computer-readable medium, the accessible resource configured to interface with any processor or application comprising the method and to store any data, records, images, information, or the like as may be needed by any processor or application comprising the method. A computer-readable medium may include a single medium or multiple media, such as but not limited to, a centralized or distributed database, and/or associated caches and servers that store one or more sets of instructions. A computer-readable medium may also include any medium that is capable of storing, encoding or carrying a set of instructions for execution by a processor or that cause a computer system to perform any one or more of the methods or operations disclosed herein. The method also comprises distributing at least one approved TC and/or at least one alternate or rejection message by a response processor configured to interface with at least one memory unit storing at least one output application for distributing at least one approved TC and/or at least one alternate message, wherein the reception, decision, and response processors are capable of interfacing with each other to coincidentally receive a user request, create a customer account, issue a user token, verify prepayment or credit line for requested transaction credit, determine approval of requested transaction credit, create a transaction credit account, which may be associated with a client and/or customer account, and distribute a transaction credit, and notification of same, and/or at least one alternate message to at least one user or third party.

In an embodiment, at least one computer-readable medium containing at least one encoded instruction corresponding to a method for providing at least one TC for it is described. A computer-readable medium may include a single medium or multiple media, such as but not limited to, a centralized or distributed database, and/or associated caches and servers that store one or more sets of instructions. A computer-readable medium may also include any medium that is capable of storing, encoding or carrying a set of instructions for execution by a processor or that cause a computer system to perform any one or more of the methods or operations disclosed herein. The corresponding method comprises receiving a request by a reception processor configured to interface with at least one memory unit, the memory unit storing at least one message application capable of receiving an authorized request to create a TC, the reception processor also configured to interface with at least one memory unit storing at least one account application capable of creating or authenticating at least one customer account associated with the request received, wherein the account application is capable of issuing at least one time-limited authorized-client-requested user token capable of facilitating a request validation and of maintaining an end user session. The request may be received through at least one application programming interface (API) enabled to facilitate access, communication, interface, interaction, and/or use of at least one component, function, element and/or aspect, etc. of at least one processor and/or at least one application, as disclosed herein, service and/or resource. The at least one API may, without limiting its composition or functionality, set rules, conventions, and/or specifications for routines, data structures, object classes, and/or protocols, or their like as may be known in the art. The API may facilitate interaction with a user, such as but not limited to customer or a client software program. A client may be a partner, associate, or approved party, of the owner, operator, or licensee of the system(s), method(s), and/or apparatus disclosed herein. The corresponding method also comprises determining whether to approve the request for TC, wherein a decision processor is configured to interface with at least one memory unit, the memory unit storing at least one evaluation application for verifying sufficient prepayment or account credit line for requested for TC, and determining whether to approve the request for TC. The corresponding method also comprises interfacing with an accessible resource encoded in a computer-readable medium, the accessible resource configured to interface with any processor or application comprising the method and to store any data, records, images, information, or the like as may be needed by any processor or application comprising the method. The corresponding method also comprises distributing at least one approved TC or an alternate or rejection message by a response processor configured to interface with at least one memory unit storing at least one output application for distributing at least one approved TC and/or an alternate message, wherein the reception, decision, and response processors are capable of interfacing with each other to coincidentally receive a user request, create a customer account, issue a user token, verify prepayment or credit line for requested transaction credit, determine approval of requested transaction credit, create a transaction credit account, which may be associated with a customer and/or client account, and distribute a transaction credit, and notification of same, and/or at least one alternate message to at least one user or third party.

### BRIEF DESCRIPTION OF THE SEVERAL VIEWS OF THE DRAWINGS

FIG. 1 is a block diagram of a system according to an embodiment of the disclosure.

FIG. 2 is a flow diagram of a method according to an embodiment of the disclosure.

FIG. 3 is a flow diagram of a procedure according to an embodiment of the disclosure.

### DETAILED DESCRIPTION

One should understand at the outset that although illustrative implementations of one or more embodiments are described below, the disclosed system(s), method(s), and apparatus may be implemented using any number of techniques. Reference to items in the singular may include those items in the plural and vice versa. The disclosure should in no way be limited to the illustrative implementations, drawings, and techniques illustrated below, but may be modified within the scope of the appended claims along with their full scope of equivalents.

An embodiment(s) of a system(s), method(s), and/or apparatus is disclosed for accepting at least one request for, determining approval of, and distributing at least one transaction credit (TC) and/or at least one alternate message. An alternate message may include a distribution that is not a TC, or that is a rejection or an error message(s) related to a request, as well as messages supplementary or complimentary to distributing a TC, such as but not limited to greeting cards, product information, special offers or advertisements. The request may be received through at least one application programming interface (API) enabled to facilitate access, communication, interface, interaction, and/or use of at least one component, function, element and/or aspect, etc. of at least one processor and/or at least one application, as disclosed herein, service and/or resource. The at least one API may, without limiting its composition or functionality, set rules, conventions, and/or specifications for routines, data structures, object classes, and/or protocols, or their like as may be known in the art. The API may facilitate interaction with a user, such as but not limited to a client or a customer software program. In some embodiments, the system(s), method(s), and/or apparatus disclosed herein may accept at least one request for at least one TC through at least one application programming interface into at least one processor that contains at least one application stored in at least one memory unit. In some embodiments, at least one processor exists with at least one application stored in at least one memory unit for determining if the at least one request for at least one TC received by the system may be approved. Approval of a TC may include creation of a TC account, which may be associated with a customer or a client account. TC accounts may be stored in an associated processor memory, or in an accessible resource. TC accounts, and/or the value therein, may be partitioned to accommodate multiple providers of prepayment or a credit line for the TC, or for sharing the use or value of a TC among more than one customer. A credit line assigned to a TC allows a TC to be issued without prepayment, but with a value assigned passed upon an approved line of credit obligated for the value of the TC. In some embodiments, at least one application of the system(s), method(s), and/or apparatus disclosed herein may receive and process authenticated messages from at least one authenticated user requesting the user's contributed TC prepayment or account credit line be combined with another user's TC prepayment or account credit line toward the purchase of at least one TC. In some embodiments, at least one processor exists with at least one application stored in at least one memory unit for distributing an approved TC and/or at least one alternate message. Distributed TCs may be fully or partially negotiable for up to their prepaid value.

In some embodiments, a TC may be any form or transmission that allows a party to apply the credit of a prepaid value of the credit toward the purchase of any item, with any seller, that may accept the value of the TC, such as but not limited to a gift card, a coupon, a purchase credit, a discount, or any similar physical or virtual form or transmission as may be known in the art. At least one accessible resource may serve as an accessible database containing all records, data, tables, figures, images or any other type information that any of the processors or applications of the system(s), method(s), and/or apparatus disclosed herein may need to conduct any function, determination, distribution, process or the like. In some embodiments, distributing the at least one TC may not require an issuer to physically produce or distribute a card. Distributing a TC, may include physical production and delivery (such as but not limited to a letter carrier delivery of a gift card), transmission in an electronic format, or any method know in the art for providing a negotiable credit to a user. In some embodiments, the at least one TC may be issued or transferred to a party(ies) other than the requestor. In some embodiments, the at least one TC may be virtual, and thus usable or transferable while existing only in an electronic format. In some embodiments, the at least one TC may be distributed in a few moments after they are requested. In some embodiments, the at least one TC may be distributed within seconds or fractions of a second of the at least one application receiving a request.

In some embodiments, at least one application of the system(s), method(s), and/or apparatus disclosed herein may coincidentally interact and accept at least one request for at least one TC—to include in some embodiments creating a new customer account, determine approval of a request—to include in some embodiments creating a new TC account that may be associated with a customer and/or client account, and distribute a TC and/or various types of alternate messages through various means. The reception, decision, and response processors are capable of interfacing with each other to coincidentally receive a user request, create a customer account, issue a user token, verify sufficient prepayment or account credit line for requested TC, determine approval, create a new TC account, and distribute a TC and notification of same, to at least one user or third party.

In some embodiments, inputs or requests to at least one of the applications of the system(s), method(s), and/or apparatus for accepting at least one request for, determining approval of, and distributing at least one TC may be in hypertext transfer protocol (HTTP) FORM GET and POST methods. Application responses or distributions may be provided in extensible markup language (XML). Network service specifications may be defined within the at least one application for request parameters and response XML format. An application programming interface (API) based on Representational State Transfer (REST) may be used for message exchange with the system(s), method(s), and/or apparatus for accepting at least one request for, determining approval of, and distributing at least one TC. In some embodiments, WEB APIs may allow combinations of multiple services in new mashups, which may also enable other site embedded content to be served through the APIs from the at least one processor or application disclosed herein. The WEB API may facilitate interaction with a user, such as but not limited to a client or a customer software program. The at least one application may require HTTP headers to accept a request to the application. The required HTTP headers may need to contain certain parameters to accept a request to the application. Such required HTTP header parameters may be required for authentication by at least one application. Authentication may include the process of establishing a client's identity with the system(s), method(s), and/or apparatus disclosed herein. A client may be a partner, associate, or approved party, of the owner, operator, or licensee of the system(s), method(s), and/or apparatus disclosed herein. The HTTP header may include but is not limited to the following information to facilitate authenticating a user and authorizing their interface with at least one application of the system(s), method(s), and/or apparatus disclosed herein: a unique client identifier, message signature, date and time of request message (possibly formatted as 2 digits each for year, month, day, hour, minute, and seconds, with 3 digits for milliseconds and time zone), a nonce value to prevent replays, encryption type (such as but not limited to Hash Message Authentication Code SHA1, SHA256, SHA 384, SHA 512, or other applicable encryption codes which may become known in the art to facilitate validating the identity of a message sender, the integrity of the message, and cryptographic non repudiation of the action), a user token, a unique device id, an end user ip address.

In some embodiments, the system(s), method(s), and/or apparatus disclosed herein may require each request to be authenticated using the request message signature. The system(s), method(s), and/or apparatus disclosed herein may require a user to authenticate with a username/password or open id and validate a session using a user token. The system(s), method(s), and/or apparatus disclosed herein may require receipt of a client_ref_id, timestamp, nonce, encryption_type, optionally usertoken along with the signature with each request to validate each message. The system(s), method(s), and/or apparatus disclosed herein may require and/or issue each allowed client of the system(s), method(s), and/or apparatus disclosed herein a Client Reference Id and a shared secret key. A client may be a partner, associate, or approved party, of the owner, operator, or licensee of the system(s), method(s), and/or apparatus disclosed herein. The secret key may be used to digitally sign the REST request. When the system(s), method(s), and/or apparatus disclosed herein receive a signed REST request, the request message may be validated by using the secret key issued to that particular client who will be identified by the client_ref_id. At least one application may calculate a new signature using the data submitted and compared against the signature sent by a client request. At least one application of the system(s), method(s), and/or apparatus disclosed herein may presume an exact match of the signatures from the client to be authentic and tamper proof; the request may be subject to further validations pending which the actual invocation of the service happens. The system(s), method(s), and/or apparatus disclosed herein may require the signature to be generated according to a specified algorithm. Such an algorithm may require the following format: base64(HmacSHA1(param1|base64-utf8(value1)|param2|base64-utf8(value2) . . . )).

In some embodiments, the system(s), method(s), and/or apparatus disclosed herein may require a procedure to create a valid message signature. Such a procedure may be described as follows. The parameters can be part of http form get or post methods. Examples of header parameters may include: (a) client_ref_id=bhnclient; (b) timestamp=090731204520876PDT; (c) nonce=090731204520876PDT; (d) usertoken=5678987656784555; (e) encryption_type=HmacSHA1; and (f) user_ip=167.22.33.44. Examples of request parameters may include: (a) firstname=fname; (b) lastname=lname; (c) cardnumber=1234567891234567891; and (d) amount=40.0. First, lexically sort all the header and request parameters by parameter name, e.g., client_ref_id, timestamp, nonce, usertoken, encryption_type, user_ip. For the above cited example parameters, the resulting sorted list would be: amount; cardnumber; client_ref_id; encryption_type; user_ip; firstname; lastname; nonce; timestamp; and usertoken. Second, Encode parameter values with base64-utf8, e.g., Base64(40.0)→NDAuMA==; Base64(1234567891234567891)→MTIzNDU2Nzg5MTIzNDU2Nzg5MQ==; Base64(bhnclient)→YmhuY2xpZW50; Base64(HmacSHA1)→SG1hY1NIQTE=; Base64(167.22.33.44)→A1PQSG1hY1NIQTE=; Base64(fname)→Zm5hbWU=; Base64(lname)→bG5hbWU=; Base(090731204520876PDT)→MDkwNzMxMjA0NTIwODc2UERU; Base64(090731204520876PDT)→MDkwNzMxMjAONTIwODc2UERU; and Base64(5678987656784555)→NTY3ODk4NzY1Njc4NDU1NQ==. Third, concatenate the sorted parameter names and their respective values separated by a pipe (|) delimiter as exemplified by the following:

amount|NDAuMA==|cardnumber|MTIzNDU2Nzg5MTIzNDU2Nzg5MQ==|client_ref_id|YmhuY 2xpZW50|encryption_type| SG1hY1NIQTE=| user_ip| A1PQSG1hY1NIQTE=|firstname|Zm5hbWU=|lastname|bG5hbWU=|nonce|MDkwNzMxMjA0NTIwODc2UERU|timestamp|MDkw NzMxMjA0NTIwODc2UERU lusertokenlNTY3ODk4NzY1Njc4NDU1NQ==. Fourth, generate the HmacSHA1 hash from the above string using secret key, e.g., HmacSHA1 (amount|NDAuMA==|cardnumber|MTIzNDU2Nzg5MTIzNDU2Nzg5MQ==|client_r ef_id|YmhuY2xpZW50|encryption_type|SG1hY1NIQTE=|user_ip|A1PQSG1hY1NIQTE=|firstna me|Zm5hbWU=|lastname|bG5hbWU=|nonce|MDkwNzMxMjA0NTIwODc2UERU|timestamp|M DkwNzMxMjA0NTIwODc2UERU|usertoken|NTY3ODk4NzY1Njc4NDU1NQ==)→7ac6d6bc39 824595b27b7a40ad188c38d12a7163. Fifth, encode the resulting sha-1 hash with base64, e.g., Base64(7ac6d6bc39824595b27b7a40ad188c38d12a7163)→N2FjNmQ2YmMzOTgyNDU5NWIy N2I3YTQwYWQxODhjMzhkMTJhNzE2Mw==. Sixth, use the above base64 encoded value N2FjNmQ2YmMzOTgyNDU5NWIyN2I3YTQwYWQxODhjMzhkMTJhNzE2Mw==as signature in the request header. Accordingly, a final such request should appear as follows: header parameters (client_ref_id=bhnclient, timestamp=090731204520876PDT, nonce=090731204520876PDT, usertoken=5678987656784555, encryption_type=HmacSHA1, user_ip=167.22.33.44); signature=N2FjNmQ2YmMzOTgyNDU5NWIyN2I3YTQwYWQxODhj MzhkMTJhNzE2Mw==; and request parameters (firstname=fname, lastname=lname, cardnumber=1234567891234567891, and amount=40.0).

In some embodiments, at least one application of the system(s), method(s), and/or apparatus disclosed herein may require clients to use nonce (number used once) to prevent the replay of transactions/requests. A client may be a partner, associate, or approved party, of the owner, operator, or licensee of the system(s), method(s), and/or apparatus disclosed herein. At least one application of the system(s), method(s), and/or apparatus disclosed herein may require that a nonce be unique across all the requests of a particular client (aka client_ref_id). A unique nonce value may be expected for each client request and it may not be repeated within 15 minutes duration. Requests with a duplicate nonce value may be declined. Additionally, at least one application of the system(s), method(s), and/or apparatus disclosed herein may require client(s) to provide the end user's IP address to prevent fraud. At least one application of the system(s), method(s), and/or apparatus disclosed herein may require that a client making a request have sufficient privileges to invoke the service. At least one application of the system(s), method(s), and/or apparatus disclosed herein may check records, data, information, or the like in the memory storing the application or in at least one accessible resource associated with the application, to ensure the request is associated with a client having sufficient privileges, before the invocation of the request. At least one accessible resource may serve as an accessible database containing all records, data, tables, figures, images, or any other type information that any of the applications of the disclosed system(s), method(s), or apparatus may need to conduct any function, determination, distribution, process or the like.

In some embodiments, the system(s), method(s), and/or apparatus disclosed herein may comprise at least one application that checks any requested image or alternate message against a word, phrase, or image choice limiter that will not accept certain designated words, phrases, or images for distribution by at least one application of the disclosed system(s), method(s), and/or apparatus. Such choice limited, unacceptable, words, phrases, or images may include at least those that are potentially offensive or profane to owner(s), operator(s), or user(s) of the disclosed system(s), method(s), and/or apparatus.

At least one processor or application of the system(s), method(s), and apparatus disclosed herein, such as the reception processor or the account application, may generate a virtual shopping cart to hold products a customer selects for purchase. In some embodiments, at least one application of the system(s), method(s), and/or apparatus disclosed herein may accept at least one request to present a collection of information about all items available in a user's shopping cart. Such information may include but is not limited to a unique id for each item, an internal product SKU, external code of the item, denomination of the item, total number of items, service fees to customize a card, service fees to purchase a card, unique carrier item id, internal id for a letter carrier, recipient(s) name, customer(s) name, any message to be printed on a letter carrier, distribution method (such as but not limited to, U.S. Postal Service, United Parcel Service, email, URL, image data, phone, SMS, or text data), date to be distributed, recipient and/or shipping address information, recipient email id, virtual card redemption URL, adjustment description (such as but not limited to discount or service fee), value adjustment (such as but not limited to fixed or percentage), associated coupon value. In some embodiments, at least one application of the system(s), method(s), and/or apparatus disclosed herein may accept and process at least one request to distribute a presentation of the total cost of the items in a customer's shopping cart. The application may calculate and distribute for presentation such information as but not limited to an order subtotal, tax, shipping cost, and shipping tax.

In some embodiments, the at least one application of the system(s), method(s), and/or apparatus disclosed herein may receive and process requests to apply a coupon code to applicable items a customer has in their shopping cart. Coupon values applied to items in a cart may be presented to a user by at least one application of the system(s), method(s), and/or apparatus disclosed for accepting at least one request for, determining approval of, and distributing at least one TC when the application accepts a request to display the total cost of items in a cart. If a request to display the total cost of items in a cart is not received, then coupon offers accepted by at least one application of the system(s), method(s), and/or apparatus disclosed for accepting at least one request for, determining approval of, and distributing at least one TC will be applied and displayed at checkout of the shopping cart. Similarly, the application may receive and process requests to remove a coupon code applied to items a customer has in their shopping cart.

In some embodiments, at least one application of the system(s), method(s), and apparatus disclosed herein utilizes a negative list check on any attribute of received request(s). The negative list table(s) may be stored in and accessible from the processor memory containing the application, in the at least one accessible resource capable of interfacing with the application, or in any other location and format known in the art to be usable by the at least one application. The at least one application stored in at least one memory unit for distributing approved TC's or alternate message(s), distributes an appropriate response error code and message when any attribute of a request(s) to the at least one application of the system(s), method(s), and apparatus is present in the negative list. An alternate message may include a distribution that is not a TC, or that is a rejection or an error message(s) related to a request, as well as messages supplementary or complimentary to distributing a TC, such as but not limited to greeting cards, product information, special offers or advertisements.

In some embodiments, at least one application of the system(s), method(s), and apparatus disclosed herein may also accept a request to distribute summary information of at least one order of a customer in a specified period, and distribute at least one message that provides the requested information. The at least one application may provide the requested information filtered by order status (such as but not limited to approved, pending, sent to fulfillment, shipped, bad data, out of stock, cancelled), start date and end date. The quantity of order information presented may be limited; in some embodiments, it may be limited to presenting only 50 orders. In some embodiments, order status and total cost of the order may also be presented. The at least one application of the system(s), method(s), and apparatus disclosed herein, may also accept a request via an authenticated message from an authenticated user for no limit, or a specified limit, on the number of orders presented. The at least one application may provide the requested information with pagination. In some embodiments, a total number of order records available may also be presented. In some embodiments, the at least one application may present all the details stored in or available to the system(s), method(s), and apparatus relating to a requested order(s). Such details may include but are not limited to total shipping cost, tax, handling cost, total cost, payment status, coupon codes applied, unique item id, name of product, group contributing to sufficient prepayment or account credit line for requested TC on at least one order, denomination of the product costs, total quantity ordered, status of item (such as but not limited to approved, pending, sent to fulfillment, shipped, cancelled, refunded), total quantity ordered, any name or message to be printed on a TC (such as but not limited to a gift card), physical card delivery carrier id, TC recipient name, customer name, any messages to be distributed to delivery carrier of a physical TC, shipping tracking number, shipping address, recipient email id, full or partial number associated with physical TC card, status of a physical TC card (such as but not limited to activated, not activated, or cancelled), and any associated adjustments (such as but not limited to discounts or service fees). In some embodiments, at least one request may be received and order-details information distributed to accompany the summary information of at least one order of a customer in a specified period.

In some embodiments, at least one application of the system(s), method(s), and/or apparatus disclosed herein may receive an authenticated message from an authenticated user requesting a refund of the purchase. The at least one application of the system(s), method(s), and/or apparatus may receive at least one request for and accept, approve and distribute, or reject a refund for an item previously purchased.

In some embodiments, interface between at least one of the applications within the system(s), method(s), and/or apparatus disclosed herein and the at least one accessible resource within or associated with the system(s), method(s), and/or apparatus allows all details, information, data, or the like stored in the at least one accessible resource(s) about a customer account to be acquired for use by any applications of the system(s), method(s), and/or apparatus. Such interface may require that an application of the system(s), method(s), and/or apparatus be in contact with a logged in authenticated user. Such data may include at least, but is not limited to phone, address, password, credit, banking, or purchase information and history.

In some embodiments, the system(s), method(s), and/or apparatus disclosed herein will accept requests to update account information in at least one accessible resource of the system(s), method(s), and/or apparatus for an existing customer account. Requests to update a customer account may require accompaniment by a user token issued by the system(s), method(s), and/or apparatus and associated with the existing customer account id. Such a customer account id may be for an account held with the owner, operator, or licensee of the system(s), method(s), and/or apparatus or with an external authorized id. The at least one accessible resource may contain but is not limited to at least one of a residence, business, shipping, billing, contact, main office, e-mail, or other related addresses, or phone numbers for accounts associated with logged in users. In some embodiments, at least one application in the system(s), method(s), and/or apparatus disclosed herein may receive requests to at update or remove at least one existing address or phone number or add at least one new address associated with a logged in user. At least one application of system(s), method(s), and/or apparatus may interface with data in at least one accessible resource to validate that any request to change, add, or update an address or phone number includes a valid address, actually usable for delivery by any method of delivery associated with the at least one application of the system(s), method(s), and/or apparatus disclosed herein for distributing a TC.

In some embodiments, interface between at least one of the applications within the system(s), method(s), and/or apparatus disclosed herein and the at least one accessible resource within or associated with the system(s), method(s), and/or apparatus allows any details, information, data or the like stored in the at least one accessible resource(s) about a client to be acquired for use by any processor or application of the system(s), method(s), and/or apparatus. Such interface may require that a processor or application of the system(s), method(s), and/or apparatus be in contact with a logged in authenticated user. Such details, information, data or the like may include at least, but is not limited to client id, legal business name, establishment date and state of incorporation, authorized representatives or agents, phone number(s), fax number(s), physical location, addresses, federal tax, credit, banking, or purchase information and history. In some embodiments, any of the details, information, data, or the like above may be received by at least one of the applications within the system(s), method(s), and/or apparatus and the at least one accessible resource within or associated with the system(s), method(s) as an authenticated message from an authenticated user, to establish at least one new client, or to update at least one existing client within the system(s), method(s), and/or apparatus. An authenticated user may be a client with a unique client id recognized by at least one application of the system(s), method(s), and/or apparatus. In some embodiments, at least one of the processors or applications within the system(s), method(s), and/or apparatus may receive an authenticated message from an authenticated user to remove any of the any of the details, information, data, or the like associated with an existing client.

In some embodiments, at least one application of the system(s), method(s), and/or apparatus disclosed herein may receive and process a request from a logged in user to present all details about a client. Such details may include but are not limited to, client name, status of the requested transaction, unique client id, legal name of the business, other names for the business, primary business type, legal entity type for business, state of incorporation, name of parent company, federal tax id, date business was established, business website address, years at physical address, Base64 representation of company logo, purpose of purchase, program type, client status (such as but not limited to approved, suspended, pending), owner information, name title, phone and address information of customer(s), unique payment identifier(s) type (such as but not limited to credit card, automated clearing house (ACH) credit, ACH debit, or wire) and name, payment card (such as but not limited to VISA, MasterCard, AMEX) data, banking data (such as but not limited to routing and account number(s), max and min currency limits. Similarly, at least one application of the system(s), method(s), and/or apparatus may receive and process an authenticated message from an authenticated user to update or remove client details, or to add or update or remove a client address.

In some embodiments, at least one application of the system(s), method(s), and/or apparatus disclosed herein may receive and process an authenticated message requesting presentation of all retailers available for a client. A client may be a partner, associate, or approved party, of the owner, operator, or licensee of the system(s), method(s), and/or apparatus disclosed herein. The quantity of retailer information presented may be limited; in some embodiments, it may be limited to presenting only 50 retailers. The at least one application may provide the requested information with pagination. In some embodiments, the at least one application may also present details stored in or available to the system(s), method(s), and apparatus relating to requested retailers available for a client. Such details may include but are not limited to, name of each retailer, retailer id, description of retailer, various URL images (such as but not limited to small, horizontal small, medium, or large), total number of pages available, total number of records available for the request, version number of each retailer catalog referenced, sequence number of the retailer, name of the category of the retailer, sequence number of the retailer in the category, response code of the request, a description.

In some embodiments, at least one request for further retailer information may be received and processed by at least one application of the system(s), method(s), and/or apparatus disclosed herein. Such information may include but is not limited to information listed above, retailer redemption information, and retailer terms and conditions.

In some embodiments, at least one request by authenticated message for presentation of the current version of a product catalog may be received and processed by at least one application of the system(s), method(s), and/or apparatus disclosed herein. Similarly, at least one application of the system(s), method(s), and/or apparatus may receive and process a request to present a catalog of all the products available for a given client. The quantity of products available for a given client presented may be limited; in some embodiments, it may be limited to presenting only 50 products. The at least one application of the system(s), method(s), and apparatus may also accept a request via an authenticated message for no limit, or a specified limit on the number of products available for a given client presented. The at least one application may provide the requested information with pagination. Presentation of product(s) available for a client may include information associated with the product(s), such as but not limited to internal stock-keeping unit (SKU), external SKU, name of product, sequence number, name of product type category, provisioning type like Giftcard/E-Giftcard, sub-type like Open/Closed loop, fixed currency denomination, minimum or maximum currency denominations, URL images, language code, country code, total number of pages available, total number of records available for any given search criteria, template id, template URL images, retailer catalog version number, retailer id, name of retailer, response code of the request, and description. In some embodiments, at least one request by authenticated message for presentation of additional product information may be received and processed by at least one application of the system(s), method(s), and/or apparatus disclosed herein. Such additional information may include but is not limited to method of TC distribution (such as but not limited to physical delivery by Shipment or virtual delivery by email, URL, phone, image data, or short message system SMS), virtual card image or card barcode image, letter carrier IID, purchase service fees, customization service fees, terms and conditions, product redemption information, card activation instructions, description of retailer, retailer redemption information, retailer terms and conditions, adjustment description (such as, but not limited to, discount, service fee, fixed, or percentage), adjustment value, adjustment start or end date(s).

In some embodiments, at least one application of the system(s), method(s), and/or apparatus disclosed herein may register a device. The at least one application may issue a unique id associated with a device that is also associated with a client. A client may be a partner, associate, or approved party, of the owner, operator, or licensee of the system(s), method(s), and/or apparatus disclosed herein. As an example, when an iPhone user downloads the at least one application, a global key and client_ref_id are downloaded as part of the download of the application, and the iPhone app used the key to sign the request and pass the client_ref_id for the authentication, authorization and accounting (AAA) layer to validate the request and invoke the registration service.

In some embodiments, the system(s), method(s), and/or apparatus disclosed herein may comprise at least one accessible resource. The accessible resource may contain all records, images, data, information, references, account numbers and/or any associated passwords, addresses, phone numbers, or the like that may be needed by any of the processors or applications of the disclosed system(s), method(s), or apparatus. In some embodiments, the accessible resource may be encoded in a computer-readable medium configured to interface with any of the processors or applications of the disclosed system(s), method(s), or apparatus. A computer-readable medium may include a single medium or multiple media, such as but not limited to a centralized or distributed database, and/or associated caches and servers that store one or more sets of instructions. A computer-readable medium may also include any medium that is capable of storing, encoding or carrying a set of instructions for execution by a processor or that cause a computer system to perform any one or more of the methods or operations disclosed herein. In some embodiments, the accessible resource may be located within a processor that may contain at least one application for receiving at least one request to create at least one TC, at least one application for determining approval of at least one request for at least one TC, or at least one application for distributing at least one TC or an alternate message. An alternate message may include a distribution that is not a TC, or that is a rejection or an error message(s) related to a request, as well as messages supplementary or complimentary to distributing a TC, such as but not limited to greeting cards, product information, special offers or advertisements. In some embodiments, the accessible resource may be located separate from, yet able to interface with, a processor that may contain at least one application for receiving at least one request to create at least one TC, at least one application for determining approval of at least one request for at least one TC, or at least one application for distributing at least one TC or an alternative message.

In some embodiments, when the system(s), method(s), and/or apparatus disclosed herein receives a request, the application receiving the request may interface with the accessible resource or the application for determining approval of the TC to recognize the account, purchase and preference history of the requester, and present for the requester images, templates, products, or other choices for TC format, products, accompanying messages, or other related information for assisting and guiding the request for TC submission. In some embodiments, at least one application of the system(s), method(s), and/or apparatus disclosed herein offers choices to a requester that may be associated with or determined by at least one product indicated by the requester. The application may accept requests for products indicated by the stock-keeping unit (SKU) code associated with the product. The interface of selection requests by a user, and the application for receiving a request, and any modifications to any display(s) or presentation(s) or choices available to initiate or submit a request may be based on the use of a Representational State Transfer Application Programming Interface (REST API).

In some embodiments, once a user request for at least one TC may be associated with an account id, at least one application of the system(s), method(s), and/or apparatus may create a new customer account, log in the user to the system(s), method(s), and/or apparatus with the account id, and assign the user a user token. At least one application of the system(s), method(s), and/or apparatus, such as but not limited to the account application may issue a user token to a first time user. At least one application of the system(s), method(s), and/or apparatus disclosed herein, such as but not limited to the output application may distribute the user token to the user. The user token may be required in the header for all subsequent application programming interface service calls. In some embodiments, the user token may expire after a set period of time. In some embodiments, the user token may expire within 30 minutes if no further requests are received from the user associated with the user token. If a user token expires, the system(s), method(s), and/or apparatus may allow a user to log in again and issue a new user token. User tokens received in a request header may also function to preserve a shopping cart previously created for a user associated with the user token.

In some embodiments, when at least one application, such as but not limited to the message application, receives a user token in a request header, any previous shopping cart created with the user token will be transferred to the newly created account associated with the user token. As long as the issued user token remains unexpired, requests received subsequent to an initial request received from a first time user, accompanied by the user token issued by at least one application of the system(s), method(s), and/or apparatus disclosed herein will be associated with all previous requests accompanied by the same user token; thereby shopping may continue, with any previously created shopping cart being consolidated with the most recently received requests associated with the same user token.

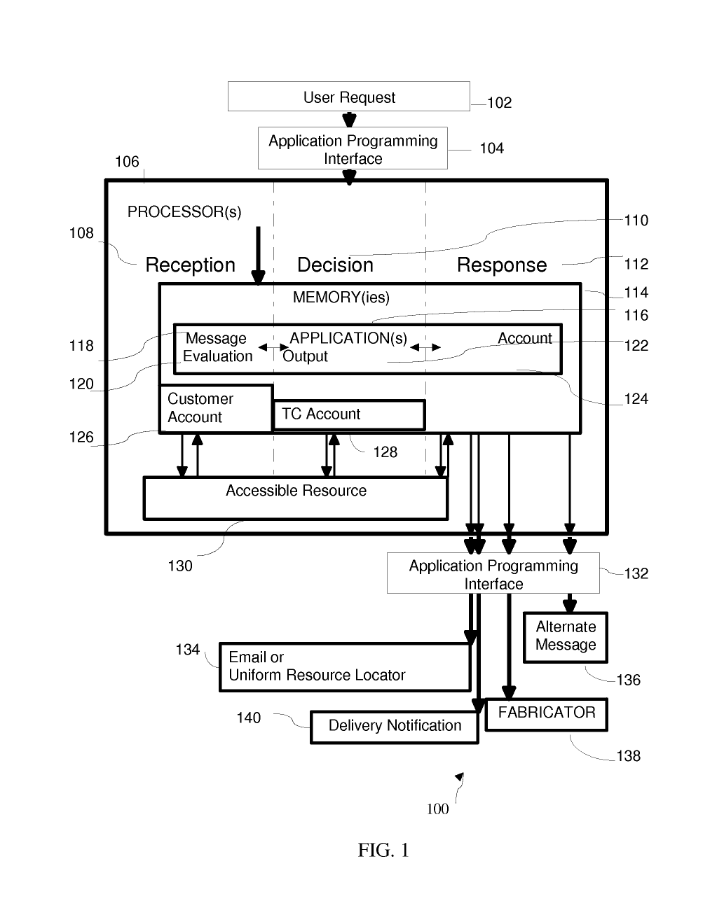

Embodiments of a system(s), method(s), and/or apparatus as disclosed herein may accommodate receiving requests from users with existing accounts, with associated data previously retained in the accessible resource, or from users without previously existing accounts, a first time user. The at least one application for receiving at least one request to create at least one TC in a system(s), method(s), and/or apparatus, such as but not limited to account application (see FIG. 1, 120) may log in users who make at least one request of the system. Such a log in may include interfacing with the at least one accessible resource and the applications for determining and distributing approval or at least one alternate message relating to the request. An alternate message may include a distribution that is not a TC, or that is a rejection or an error message(s) related to a request, as well as messages supplementary or complimentary to distributing a TC, such as but not limited to greeting cards, product information, special offers or advertisements.

In some embodiments, at least one application of the system(s), method(s), and/or apparatus disclosed herein may receive an account id and password as parameters to create a new customer account. A received account id may be an id for account(s) with the owner, operator, or licensee of the system(s), method(s), and/or apparatus or an id for an authorized external user of the system(s), method(s), and/or apparatus. A valid id for an account(s) with the owner, operator, or licensee of the system(s), method(s), and/or apparatus may be but is not limited to a valid email address. A password may be limited to some number or type of characters to be valid, accepted by at least one of the applications in the system(s), method(s), and/or apparatus disclosed herein. A valid password may be case sensitive. A valid password may require some number of characters; in some embodiments, it may require at least five characters. At least one application in a system(s), method(s), and/or apparatus disclosed herein may receive requests to change a password from, and transmit a changed password to, logged in users with existing account(s) with the owner, operator, or licensee of the system(s), method(s), and/or apparatus. However, the at least one application in a system(s), method(s), and/or apparatus disclosed herein may not receive requests to change a password from users with external authorized id account(s). Authorized external users and their associated id's, and all associated order history, may be preserved in at least one accessible resource associated with at least one application of the system(s), method(s), and/or apparatus disclosed herein. A password may not be required if the system(s), method(s), and/or apparatus disclosed herein recognizes the request as being accompanied by an id from an authorized external user of the system(s), method(s), and/or apparatus.

In some embodiments, at least one application of the system(s), method(s), and/or apparatus disclosed herein may provide a shopping cart service. The at least one application may allow a user to deposit a purchase selection, including at least one TC to be distributed in a physical or virtual format, into a shopping cart. The at least one application also may accept and processes requests to remove any item, or clear all items, selected into a shopping cart.

The application presents various types and forms of TC's for selection by a user, or shopper, such as but not limited to virtual or physical cards. The at least one application may differentiate various types and forms of TC's for selection by a user offered to a shopper based on the internal SKU assigned to a particular TC. If the TC distribution is to be as a virtual card, the application may solicit and allow receipt of user preference for email or URL distribution. If the at least one application does not receive a preference selection for the type of virtual card distribution, the application may distribute the virtual card directly to the recipient's email address. If the TC chosen is a physical card, then the application may solicit and allow receipt of user preference for ship method and the shipping address. In some embodiments, at least one application may receive at least one distribution preference at the time the TC is initially selected for addition to a shopping cart, or may be accepted later. Similarly, at least one application of the system(s), method(s), and/or apparatus may accept preference requests for TC distribution packaging options or additional messages, or items to accompany distribution of a physical card TC. At least one application system(s), method(s), and/or apparatus may not accept requests for selectable packaging when the requests are for bulk numbers of TC's; in some embodiments bulk quantities are those greater than fourteen.

When at least one application accepts a request for a TC that is an open loop card (general purpose cards, such as but not limited to those that carry the American Express, Discover, MasterCard or Visa logo) then it will also offer and accept at least one authenticated message from an authenticated user requesting to add personalization information (such as but not limited to recipient's name or a other printing) to at least one TC card. In some embodiments, at least one application of the system(s), method(s), and/or apparatus disclosed herein may accept and process a request to remove one or more previously distribution requests. Such a request to remove a previous distribution request may be received and processed up until an item has actually been distributed, has left the control of the owner, operator, or licensee of the system(s), method(s), and/or apparatus disclosed herein.

The processor or application deciding whether to approve a request for a TC, such as but not limited to the decision processor or evaluation application may create a TC account that may be associated with a preexisting or newly created customer and/or client account. The TC account created may reside within a processor memory or the accessible resource associated with the processor creating the TC. The TC account may be partitioned to accommodate multiple providers of prepayment or a credit line for the TC, or for sharing the use or value of a TC among more than one customer. A credit line assigned to a TC allows a TC to be issued without prepayment, but with a value assigned passed upon an approved line of credit obligated for the value of the TC. In some embodiments, at least one application of the system(s), method(s), and/or apparatus disclosed herein may accept and process at least one authenticated message from an authenticated user requesting checkout and accepting payment for the items in a customer's shopping cart. Receiving and processing a request for checkout and payment generates an order to at least one application of the system(s), method(s), and/or apparatus to create an order to distribute the purchased TC's. At least one application of the system(s), method(s), and/or apparatus may accept payment inputs as common to the art at least by but not limited to the following formats: credit card, purchase order, Itunes account, gift card, ACH credit, wire, ACH debit. In some embodiments, the at least one TC distributed may be in the form of an email or uniform resource locator (URL), which in some embodiments may allow the email or URL recipient to fabricate a physical form for at least one TC, such as but not limited to printing or stamping with bar or other visible coding.

In some embodiments, distribution of at least one TC may include physically fabricating, packaging, and shipping the TC to a recipient. The physical form of the at least one TC produced may be a card encoded with visible or tactile surface printing, magnetically stored data, optical machine-readable representation of data, an embedded microchip (such as but not limited to a smart card), radio-frequency identification or other encoding, or any article, printout, or other format used in the art at any time that may be understood or accepted as representing a negotiable credit toward a transaction. At least one application of the system(s), method(s), and/or apparatus as disclosed herein may accept inputs of information facilitating distribution of at least one requested TC to a party not submitting the request. The at least one TC may be distributed in a format that may be transferable for use with partial, or without, restriction by or may be distributed directly to, a party who is not the requester of the at least one TC. Such recipient information may be stored for reference in at least one memory or accessible resource associated with the application, or in any manner known in the art to be accessible by the application.

In some embodiments, TC's distributed by at least one application of the system(s), method(s), and/or apparatus disclosed herein may not be negotiable until activated. Such TC activation may require at least one application of the system(s), method(s), and/or apparatus disclosed herein to receive an identification number authorization associated with the distributed TC. At least one application of the system(s), method(s), and/or apparatus disclosed herein may allow TC redemption or value reload or modification. At least one application of the system(s), method(s), and/or apparatus disclosed herein may accept and process authenticated messages requesting distribution of a presentation of the value remaining on a previously distributed TC, a balance inquiry. At least one application of the system(s), method(s), and/or apparatus disclosed herein may allow receipt of a request to permanently, or temporarily, void the negotiable value of a distributed TC if a unique transaction id associated with the request is identical to the unique transaction id associated with the original request and prepayment or sufficient credit line for the TC.

In some embodiments, when the system(s), method(s), and/or apparatus receives at least one request to distribute at least one TC in a virtual format (one not physically produced and delivered by the system(s), method(s), and/or apparatus), if the request was for an email distribution, the system(s), method(s), and/or apparatus may send out an email to the recipient with all the necessary attributes associated with a negotiable TC. If the request received was to distribute at least one TC as a URL, then the system(s), method(s), and/or apparatus may construct the URL and distribute it along with the response. If the request received was to distribute at least one TC as an image, then the system(s), method(s), and/or apparatus may construct a Base64 representation of the image binary data in the response xml. If the request received was to distribute at least one TC as text data, then the system(s), method(s), and/or apparatus may send the data as text in the response XML Any information and format in the art that may be effective to function as a negotiable TC via a nontangible medium, such as but not limited to an automated aural, digital, or text phone message, may also be distributed by at least one application of the system(s), method(s), and/or apparatus. If the request received was to distribute at least one TC, with notification of the distribution via social media device, such as but not limited to, Facebook Wall or Twitter, then the then the system(s), method(s), and/or apparatus may distribute the virtual TC and post a message to the recipient's social media device, such as but not limited to, Facebook Wall or Twitter. In some embodiments, at least one application the of the system(s), method(s), and/or apparatus may receive an authenticated message, from an authenticated user tendering prepayment or sufficient credit line for a requested TC, requesting that distribution of at least one TC be delayed until a specified time in the future. In some embodiments of the system(s), method(s), and/or apparatus disclosed for accepting at least one request for, determining approval of, and distributing at least one TC, at least one application may receive an authenticated message from an authenticated user requesting any personal message be added to the distribution of the TC.

In some embodiments, the type of distribution of the TC may be determined by the at least one application for determining approval for the at least one requested TC, the evaluation application (see FIG. 1, 122), or by the at least one application for distributing the at least one requested TC, the output application (see FIG. 1, 124). In other embodiments, the request for at least one TC may include but is not limited to a designation of the type of distribution requested for the TC. In some embodiments, additional requests may accompany the request for at least one TC. Such requests may include customized formatting or imagery of the TC, or of a desired message or imagery to accompany the transmission of the TC. In some embodiments, the selectable format, imagery, or messages accompanying a TC may be limited. In some embodiments, the system(s), method(s), and/or apparatus disclosed herein may allow customization selections from preset images, or preformed templates. Customized templates may be associated with a product stock-keeping unit (SKU). In some embodiments, if the at least one request input coordinates are not within the limits as specified in the preformed templates, then the at least one application for distributing TC approval or at least one alternate message, may transmit an error message, such as but not limited to those listed in paragraph [0049]. In some embodiments, customization selections may only be made from preset images, or preformed templates, or messages may be limited in length. Customization templates may be for at least one gift card or for at least one gift carrier, or package, template. In some embodiments, receipt of customized text requests may be limited to 500 characters or less. Customized images may be added to an item using a “multipart/form-data” content type. In some embodiments, the at least one application receiving the at least one request for at least one TC, or the at least one application for determining approval of the at least one request for at least one TC may attempt to validate coordinate inputs of the received request against coordinates for a base template. In some embodiments, at least one application of the system(s), method(s), and/or apparatus may be configured to receive client requests to modify extensible markup language (XML) detailing requests for a customized form of TC card or alternate message distribution. An alternate message may include a distribution that is not a TC, or that is a rejection or an error message(s) related to a request, as well as messages supplementary or complimentary to distributing a TC, such as but not limited to greeting cards, product information, special offers or advertisements. In some embodiments, all customized XML may be stored in the at least one accessible resource for reference or use by any of the applications of the system(s), method(s), and/or apparatus disclosed herein.

In some embodiments, any selection of any customized options, or accompanying text, or preferred choice of template for a TC or its accompanying messages, or its transmission may be stored in the at least one accessible resource for future reference, use, or presentation to or by a requester to or by any part of, or application within or associated with, the system(s), method(s), and/or apparatus disclosed herein, or by the owner, operator, or TC issuer operating the system(s), method(s), and/or apparatus disclosed herein.

In some embodiments, at least one application of the system(s), method(s), and/or apparatus disclosed herein may accept and process at least one authenticated message from an authenticated user requesting to add a distribution notification. Such notification(s) may be to such parties as designated in the request, and be distributed by email, URL, text messaging, to a social media device, such as but not limited to, Facebook Wall or Twitter, or any other communication distribution as may be known in the art. At least one application can also accept and process at least one authenticated message from an authenticated user requesting to remove one or more distribution notification(s) up until the notification is distributed.

In some embodiments, at least one application of the system(s), method(s), and/or apparatus disclosed herein may distribute to at least one user, a presentation of at least one store location. The distributed at least one store location may be limited to alliance partners of the owner, operator, or licensee of the system(s), method(s), and/or apparatus disclosed herein. The distributed at least one store location may be limited to card partners of the owner, operator, or licensee of the disclosed system(s), method(s), and/or apparatus. The distributed at least one store location may be limited to at least one store within a specified radius from the user location or a designated location. The at least one application may accept a request to designate the specified radius and/or center point location for the specified radius for a store location listing. The at least one application may accept the center point location in various formats such as but not limited to physical address, latitude/longitude data, street, city, state, country, postal zip code, position of device communicating with the application, or any other manner or format known in the art for designating a location. In some embodiments, at least one application may also provide additional information about stores such as but not limited to store hours, phone numbers, description, consumer ratings, links to store websites, store coupons, store catalogs, a user's prior purchases, leading items sold at such stores, or other information that may aid, inform, or entertain a user. I

At least one application of the disclosed system(s), method(s) for accepting at least one request for, determining approval of, and distributing at least one TC and/or at least one alternate message (such as but not limited to a request rejection, information related to a request, required corrections for a request, any personal messages to be distributed with the requested TC, or other information related to a request) may distribute an error message to the client when the application receives a request that is not authorized. At least one accessible resource associated with at least one application of the system(s), method(s), and/or apparatus disclosed herein may store requested personalized, supplementary, complimentary, or customized messages or images for distribution with or as an alternative to a TC. Such accessible resource stored messages may be accessible for future use by any processor or application of the disclosed system(s), method(s), and/or apparatus.

In some embodiments, in addition to personalized, supplementary, complimentary, or customized messages or images for distribution with or as an alternative to a TC, error messages may be distributed. Error messages may include, but are not limited to, those listed in the following Tables 1-11, below:

TABLE 1
Authentication Authorization and Auditing Response Codes

| Response Code | Description |
|---|---|
| AAA_901 | Invalid Signature |
| AAA_902 | Duplicate Nonce value |
| AAA_903 | Expired User Token |
| AAA_904 | Client not authorized for this request |
| AAA_905 | Invalid Timestamp |
| AAA_906 | Invalid Authorization Header |
| AAA_907 | Invalid Request |

TABLE 2
Account Service Response Codes

| Response Codes | Description |
|---|---|
| ACC_000 | Success |
| ACC_050 | Failed - Invalid Email address |
| ACC_051 | Failed - Invalid password |
| ACC_052 | Failed - Invalid Phone number |
| ACC_053 | Failed - Email address is already in use |
| ACC_054 | Failed - Invalid First Name |
| ACC_055 | Failed - Invalid Last Name |
| ACC_056 | Failed - Invalid Phone |
| ACC_057 | Failed - Invalid Address Type |
| ACC_058 | Failed - Invalid Address1 |
| ACC_059 | Failed - Invalid City |
| ACC_060 | Failed - Invalid State |
| ACC_061 | Failed - Invalid Zip code |
| ACC_062 | Failed - Invalid Country |
| ACC_063 | Failed - Invalid bhnaddressid |
| ACC_064 | Failed - Invalid Email address |
| ACC_065 | Failed - Invalid Password |
| ACC_066 | Failed - Invalid old password |
| ACC_067 | Failed - Invalid new password |
| ACC_068 | Failed - Account Not Created |
| ACC_069 | Failed - Account Not Updated |
| ACC_070 | Failed - Guest User Token not Issued |
| ACC_071 | Failed - Unable to login |
| ACC_072 | Failed - Unable to change password |
| ACC_073 | Failed - Unable to get Addresses |
| ACC_074 | Failed - Invalid Account Id |
| ACC_075 | Failed - Invalid Contact flag |
| ACC_076 | Failed - Unable to Add the address |
| ACC_077 | Failed - Unable to update the address |
| ACC_078 | Failed - Unable to remove the address |
| ACC_079 | Failed - BHN Account exists |
| ACC_080 | Failed - Account does not exist |

TABLE 3
Card Service Response Codes

| Response Codes | Description |
|---|---|
| CAD_000 | Success |
| CAD_015 | Card will be activated in 24 hours |
| CAD_050 | ! Unable to route/System Error |
| CAD_051 | ! Time Out occurred - Auth Server not |
| | available/responding |
| CAD_052 | Refer to card issuer |
| CAD_053 | Error account problem |
| CAD_054 | Invalid expiration date |
| CAD_055 | Unable to process |
| CAD_056 | Card not found in database |
| CAD_057 | Invalid transaction |
| CAD_058 | Invalid amount |
| CAD_059 | Invalid card number/invalid status |
| CAD_060 | Invalid merchant |
| CAD_061 | Invalid Pin |
| CAD_062 | Card already active |
| CAD_063 | Bad Track2 data - format error |
| CAD_064 | Expired card |
| CAD_065 | Restricted card |
| CAD_066 | Lost card |
| CAD_067 | Stolen card |
| CAD_068 | Insufficient card |
| CAD_069 | Expired card |
| CAD_070 | Max recharge reached |
| CAD_071 | Advance less amount/enter lesser amount |
| CAD_072 | Exceeds withdrawal amt/over limit |
| CAD_073 | Exceeds withdrawal frequency limit |
| CAD_074 | Format error - bad data |
| CAD_075 | Duplicate transaction |
| CAD_076 | General decline |
| CAD_077 | Unable to activate your card - Invalid |
| | bulk order number. |
| CAD_078 | Invalid Card/Invalid Activation Code |
| CAD_079 | Invalid status |
| CAD_080 | Technical Difficulties |

TABLE 4
Distribution/Fulfill Service Response Codes

| Response | |
|---|---|
| Codes | Description |
| FLF_000 | Success |
| FLF_050 | ! Payment is not approved |
| FLF_051 | ! Time Out occurred - Auth Server not available/responding |
| FLF_052 | ! Card not available |
| FLF_053 | ! Order is not approved |
| FLF_054 | bhnitemid is not matching to client reference id - Invalid |
| | authorization |
| FLF_055 | Unable to process |
| FLF_056 | Cart not found in database |
| FLF_057 | General decline |
| FLF_058 | bhnitemid does not match to process code |
| FLF_059 | Invalid bhnitemid |
| FLF_060 | Invalid Server state |
| FLF_061 | Technical difficulties |
| CAD_000 | Approved - balance available |
| CAD_001 | Approved - balance unavailable |
| CAD_050 | ! Unable to route/System Error |
| CAD_051 | ! Time Out occurred - Auth Server not available/responding |
| CAD_052 | Refer to card issuer |
| CAD_053 | Error account problem |
| CAD_054 | Invalid expiration date |
| CAD_055 | Unable to process |
| CAD_056 | Card not found in database |
| CAD_057 | Invalid transaction |
| CAD_058 | Invalid amount |
| CAD_059 | Invalid card number/invalid status |
| CAD_060 | Invalid merchant |
| CAD_061 | Invalid Pin |
| CAD_062 | Card already active |
| CAD_063 | Bad Track2 data - format error |
| CAD_064 | Expired card |
| CAD_065 | Restricted card |
| CAD_066 | Lost card |
| CAD_067 | Stolen card |
| CAD_068 | Insufficient card |
| CAD_069 | Expired card |
| CAD_070 | Max recharge reached |
| CAD_071 | Advance less amount/enter lesser amount |
| CAD_072 | Exceeds withdrawal amt/over limit |
| CAD_073 | Exceeds withdrawal frequency limit |
| CAD_074 | Format error - bad data |
| CAD_075 | Duplicate transaction |
| CAD_076 | General decline |
| CAD_077 | Unable to activate your card - Invalid bulk order number. |
| CAD_078 | Invalid Card/Invalid Activation Code |
| CAD_079 | Invalid status |
| CAD_080 | Technical Difficulties |

TABLE 5
Customization Response Codes

| Response | |
|---|---|
| Codes | Description |
| CZT_000 | Success |
| CZT_050 | Failed to load templates - No templates defined for the item. |
| CZT_051 | Failed to load templates - System error. |
| CZT_052 | Failed to load template details - Details re not available |
| | for this template. |
| CZT_053 | Failed to load template details - System error. |
| CZT_054 | Failed to save customization details - the text/image |
| | is exceeding the specified limit. |
| CZT_055 | Failed to save customization details - System error |
| CZT_056 | Failed to add image to item - System error |
| CZT_057 | Failed to add text to item - System error |
| CZT_058 | Item Id is missing |
| CZT_059 | Template Id is missing |
| CZT_060 | Data Area is missing |
| CZT_061 | Item is invalid |
| CZT_062 | Image is missing |
| CZT_063 | Text is missing |
| CZT_064 | Invalid data area |
| CZT_065 | Invalid Template Id |

TABLE 6
Card Generation response Codes

| Response | |
|---|---|
| Codes | Description |
| CDG_000 | Success |
| CDG_050 | ! Payment is not approved |
| CDG_051 | ! Time Out occurred - Auth Server not available/responding |
| CDG_052 | ! Card not available |
| CDG_053 | ! Order is not approved |
| CDG_054 | bhnitemid is not matching to client reference id - Invalid |
| | authorization |
| CDG_055 | Unable to process |
| CDG_056 | Card not found in database |
| CDG_057 | General decline |
| CDG_058 | bhnitemid does not match to process code |
| CDG_059 | Invalid bhnitemid |
| CDG_060 | Invalid Server state |
| CDG_061 | Technical difficulties |

TABLE 7
Shopping Cart response Codes

| Response | |
|---|---|
| Codes | Description |
| CRT_000 | Success |
| CRT_050 | Invalid BHN ID (Product SKU) |
| CRT_051 | Invalid Letter carrier ID (Letter Carrier SKU) |
| CRT_052 | Invalid Shipping Method |
| CRT_053 | Ship To First Name is missing |
| CRT_054 | Ship To Last Name is missing |
| CRT_055 | Ship To Company is missing |
| CRT_056 | Ship To Address Type is missing |
| CRT_057 | Ship To Address1 is missing |
| CRT_058 | Ship To Address2 is missing |
| CRT_059 | Ship To City is missing |
| CRT_060 | Ship To State is missing |
| CRT_061 | Ship To Country is missing |
| CRT_062 | Ship To phone is missing |
| CRT_063 | Invalid zip code |
| CRT_064 | Invalid State |
| CRT_065 | Invalid Country |
| CRT_066 | Billing First Name is missing |
| CRT_067 | Billing Last Name is missing |
| CRT_068 | Billing Company is missing |
| CRT_069 | Billing Address Type is missing |
| CRT_070 | Billing Address1 is missing |
| CRT_071 | Billing Address2 is missing |
| CRT_072 | Billing City is missing |
| CRT_073 | Billing State is missing |
| CRT_074 | Billing Country is missing |
| CRT_075 | Fulfillment details are mandatory for each item |
| CRT_076 | Packaging Info is necessary |
| CRT_077 | Invalid Payment Option |
| CRT_078 | Payment Error |
| CRT_079 | Failed to add item - System error. |
| CRT_080 | Failed to add packaging to item - System error. |
| CRT_081 | Failed to add physical fulfillment to item - System error. |
| CRT_082 | Failed to add virtual fulfillment to item - System error. |
| CRT_083 | Failed to remove item - System error. |
| CRT_084 | Failed to retrieve cart - System error. |
| CRT_085 | Failed to clear cart - System error. |
| CRT_086 | Failed to apply coupon - System error. |
| CRT_087 | Failed to remove coupon - System error. |
| CRT_088 | Failed to review cart - System error. |
| CRT_089 | Failed to checkout - System error. |
| CRT_090 | Item is invalid |
| CRT_091 | No results found |
| CRT_092 | Invalid Coupon |
| CRT_093 | Coupon Expired |
| CRT_094 | BHN ID Missing (Product SKU) |
| CRT_095 | Denomination is missing |
| CRT_096 | Quantity is missing |
| CRT_097 | Letter Carrier ID is missing |
| CRT_098 | Fulfillment Type is missing |
| CRT_099 | Recipient Email Address is missing |
| CRT_100 | Invalid Denomination |
| CRT_101 | Invalid fulfill method |
| CRT_102 | Email Address is missing |
| CRT_103 | Partner limit Exceeded |
| CRT_104 | USPS_FIRST_CLASS is not supported for quantity |
| | greater than 14 |
| CRT_105 | Invalid Shipping Address Id |
| CRT_106 | Failed to add personalization to item - System error |
| CRT_107 | Personalization is supported for open loop items only. |
| CRT_108 | Invalid fulfill on date |

TABLE 8
Order Response Codes

| Response | |
|---|---|
| Codes | Description |
| ORD_000 | Success |
| ORD_051 | Failed to retrieve orders - System error. |
| ORD_052 | Failed to retrieve order details - System error. |
| ORD_053 | Failed to fulfill an item - System error. |
| ORD_054 | Failed to refund - System error. |
| ORD_055 | Failed to add recipient - System error. |
| ORD_056 | No results found. |
| ORD_057 | Item is invalid. |
| ORD_058 | Payment not captured or authorized. |
| ORD_059 | Invalid payment option |
| ORD_060 | Failed to add contribution |

TABLE 9
Payment Response Codes

| Response Codes | Description |
|---|---|
| PAY_000 | Success |
| PAY_101 | The request is missing one or more required fields. |
| PAY_102 | One or more fields in the request contain invalid data. |
| PAY_150 | General system failure. |
| PAY_151 | The request was received but there was a server timeout. This error does not |
| | include timeouts between the client and the server. |
| PAY_200 | The authorization request was approved by the issuing bank but declined by |
| | CyberSource because it did not pass the Address Verification Service (AVS) |
| | check. |
| PAY_201 | The issuing bank has questions about the request. You do not receive an |
| | authorization code programmatically, but you might receive one verbally by |
| | calling the processor. |
| PAY_202 | Expired card. You might also receive this if the expiration date you provided |
| | does not match the date the issuing bank has on file. |
| PAY_203 | General decline of the card. No other information provided by the issuing |
| | bank. |
| PAY_204 | Insufficient funds in the account. |
| PAY_205 | Stolen or lost card. |
| PAY_207 | Issuing bank unavailable. |
| PAY_208 | Inactive card or card not authorized for card-not-present transactions. |
| PAY_209 | American Express Card Identification Digits (CID) did not match. |
| PAY_210 | The card has reached the credit limit. |
| PAY_211 | Invalid card verification number. |
| PAY_221 | The customer matched an entry on the processor's negative file. |
| PAY_230 | The authorization request was approved by the issuing bank but declined by |
| | CyberSource because it did not pass the card verification (CV) check. |
| PAY_231 | Invalid account number. |
| PAY_232 | The card type is not accepted by the payment processor. |
| PAY_233 | General decline by the processor. |
| PAY_234 | There is a problem with your CyberSource merchant configuration. |
| PAY_235 | The requested amount exceeds the originally authorized amount. Occurs, for |
| | example, if you try to capture an amount larger than the original authorization |
| | amount. |
| PAY_236 | Processor failure. |
| PAY_237 | The authorization has already been reversed. |
| PAY_238 | The authorization has already been captured. |
| PAY_239 | The requested transaction amount must match the previous transaction |
| | amount. |
| PAY_240 | The card type sent is invalid or does not correlate with the credit card number. |
| PAY_241 | The request ID is invalid. |
| PAY_242 | You requested a capture, but there is no corresponding, unused authorization |
| | record. Occurs if there was not a previously successful authorization request |
| | or if the previously successful authorization has already been used by another |
| | capture request. |
| PAY_246 | The capture or credit is not voidable because the capture or credit information |
| | has already been submitted to your processor. Or, you requested a void for a |
| | type of transaction that cannot be voided. |
| PAY_247 | You requested a credit for a capture that was previously voided. |
| PAY_250 | The request was received, but there was a timeout at the payment processor. |
| PAY_476 | The Card Authentication failed. Please try another payment method. |
| PAY_999 | Service Failure |

TABLE 10
Product Catalog Response Codes

| Response Codes | Description |
|---|---|
| PRD_000 | Success |
| PRD_051 | Failed to retrieve product catalog - System error. |
| PRD_052 | Failed to retrieve product info - System error. |
| PRD_053 | No product information found for the given BHNIID. |
| PRD_054 | Not authorized to view the product. |
| PRD_055 | No results found. |
| PRD_056 | Failed to retrieve Retailer catalog - System error |
| PRD_057 | Your version is current |
| PRD_058 | Invalid version number |

TABLE 11
Store Locator Response Codes

| Response Codes | Description |
|---|---|
| STL_000 | Success |
| STL_051 | Invalid input location |
| STL_052 | Invalid radius |
| STL_053 | Invalid partner code |
| STL_054 | Incorrect partner type |
| STL_054 | No results found |

Turning now to FIG. 1, an embodiment of a system 100 for accepting at least one request 102 for determining approval of and distributing at least one transaction credit (TC) and/or at least one alternate message 136 is disclosed. An alternate message may include a distribution that is not a TC, or that is a rejection or an error message(s) related to a request, as well as messages supplementary or complimentary to distributing a TC, such as but not limited to greeting cards, product information, special offers or advertisements. In an embodiment, the system 100 comprises a processor 106 configured to accept a request 102 which may be received through an application programming interface 104. The request 102 may be received through at least one application programming interface 104 enabled to facilitate access, communication, interface, interaction, and/or use of at least one component, function, element and/or aspect, etc. of at least one processor 106 and/or at least one application 116, as disclosed herein, service and/or resource. The at least one application programming interface 104 may, without limiting its composition or functionality, set rules, conventions, and/or specifications for routines, data structures, object classes, and/or protocols, or their like as may be known in the art. The application programming interface 104 may facilitate interaction with a user, such as but not limited to a client or a customer software program. The at least one processor 106 is configured to interface with a memory unit 114, and may be portioned to comprise a reception processor 108, a decision processor 110, and a response processor 112 configured to interface with each other, alternatively the processor 106 may be configured to perform the functions of the reception processor 108, the decision processor 110, and the response processor 112 sans pardoning. The memory unit 114 may store the at least one application 116. The memory unit 114 may store a message application 118 and an account application 120 associated with the reception processor 108. The account application 120 may create and/or store in the reception processor 108 memory unit 114, a customer account 126. The memory unit 114 may store an evaluation application 122 associated with the decision processor 110. The evaluation application 122 may create and/or store in the decision processor 110, at least one transaction credit (TC) account 128. The memory unit 114 may store an output application 124 associated with the response processor 112. Any application of the system may interface with an accessible resource 130, which is capable of storing and providing all information, data, records, templates, forms, images, or the like as needed by any application of the system. Output of the response processor 112 is transmitted through at least one application programming interface 132 as a virtual TC in email or uniform resource locator 134 format, as an alternate message 136, or as a command to a fabricator 138. The fabricator 138 produces a TC in a physical format for carrier delivery. The at least one application programming interface 132 is enabled to transmit, communicate, interface, interact, and/or output at least one component, function, element, product, and/or aspect, etc. of at least one processor 106 and/or at least one application 116, as disclosed herein, service and/or resource. The at least one application programming interface 132 may, without limiting its composition or functionality, set rules, conventions, and/or specifications for routines, data structures, object classes, and/or protocols, or their like as may be known in the art. The application programming interface 132 may facilitate interaction with user, such as but not limited to a client or a customer software programs.

Each processor 106-112 and each application 116-124 of the system 100 as embodied by FIG. 1 is capable to interface with any other processor or application of the system to coincidentally receive a user request, create a customer account, issue a user token verify sufficient prepayment or account credit line for requested a TC, approve and distribute a TC, and notification of same, to at least one user or third party. The processors 108-112 and applications 116-124 of the disclosed system 100 may be directly adjacent and physically connected in any manner known in the art, such as but not limited to interconnected hardware modules, integrated circuits, programmable logic arrays, or other devices. The processors 108-112 and applications 116-124 of the disclosed system 100 may be joined as an integrated network of physically separated components integrally functioning via but not limited to distributed, component/object distributed, or parallel processing through Ethernet, Cloud, or other known protocols as may be known in the art.

Variations of the embodiment of FIG. 1 may include configurations of the single memory unit 114 subdivided into distinct memory units associated with each processor. An authorized client may utilize an application programming interface capable of interfacing with the application programming interface 104 located within the system processor 106. A request 102, received from an authorized client may come as an authenticated message from a user through an authorized client of the system 100. A request 102 may be for a TC for a user or a third party, or for numerous other processing by or distributions from the system(s), method(s), and/or apparatus disclosed herein, such as but not limited to creating an account, activating, reloading, or redeeming a TC, inquiring on remaining value of an issued TC, voiding a transaction, customized formatting or imagery of the TC, or of a desired message or imagery to accompany the transmission of the TC, summary information of at least one order of a customer in a specified period, or gathering information about users, clients, purchases, or products. A request 102 may come through an application programming interface from a site controlled by an authorized client of the system, or directly from a user utilizing an authorized client supplied application programming interface. The accessible resource 130 may be as depicted in FIG. 1, or stored within the memory unit 114, or be completely separate from but linked to interface with the processor 106. Not shown in FIG. 1, at least one customer account 126 and at least one transaction account 128 may be stored in the accessible resource 130 as an alternate location to that shown in FIG. 1. The alternate message 136 may be output either independent of the email or uniform resource locator 134 or fabricator 138 output, or as a message or complimentary or supplementary thereto. Delivery notification 140 may be by any manner known to one in the art, such as but not limited to an email or social media device, such as but not limited to Facebook Wall or Twitter posting. Delivery notification 140 may be distributed simultaneously, or distinctly, to a system user, a TC or alternate message recipient, or other third parties as approved by the system.

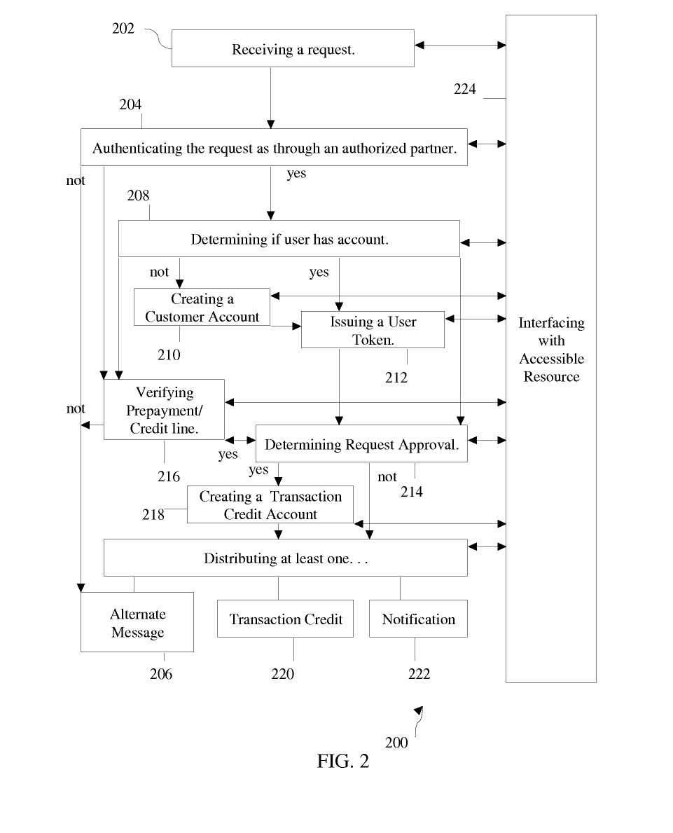

Turning now to FIG. 2, a flow chart for an embodiment of a method 200 comprising accepting at least one request for, determining approval of, and distributing at least one transaction credit 218 (TC) and/or at least one alternate message and notification is disclosed. The diagram of the method embodiment discloses, at block 202, receiving a request, and at block 204, authenticating the request as through an authorized client of the owner, operator, or licensee of the method disclosed herein. If the request is not received through an authorized client, then at block 206, distributing at least one alternate message is shown. An alternate message may include a distribution that is not a TC, or that is a rejection or an error message(s) related to a request, as well as messages supplementary or complimentary to distributing at least oneTC 220, such as but not limited to greeting cards, product information, special offers or advertisements. The diagram further discloses, at block 208, determining if a user submitting the request through an authorized client has an account with the owner, operator, or licensee of the method, at block 210, creating an account for the user if one did not previously exist, at block 212, issuing a user token to the user, at block 214, determining whether to approve a request, which may include verifying sufficient prepayment or account credit line for requested TC 218 as shown at block 216. Creating a transaction credit (TC) account 218, which may be associated with a customer or client account, may follow approval of a TC. When determining request approval 214 is affirmative, then distributing a TC 220 results. Distributing at least one notification 222 of at least one TC 220 approval, and distributing at least one alternate message 206 may also result. When determining request approval is negative, then distributing at least one alternate message 206, such as but not limited to an error message or rejection results. Distributing at least one alternate message 206, at least one TC 220, or at least one notification 222 may occur coincidentally, individually, delayed until a requested or determined later time, or not at all. Further, distributing at least one alternate message 206 may include distributing messages supplementary or complimentary to distributing at least one TC 218, such as but not limited to greeting cards or advertisements. Disclosed at block 224, is coincidental capability of the accessible resource for interfacing with all other blocks comprising the embodiment of the method. The multiple flow paths between the blocks in FIG. 2 illustrates that the processors of the method disclosed are capable of interfacing with each other to enable coincidentally receiving a user request 202, creating a customer account 210, issuing a user token 212, verifying sufficient prepayment or account credit line 216 for requested TC, determining request approval 214, creating a TC account 218, and distributing at least one TC 220, notification 222, and or at least one alternate message 206 of same, to at least one user or third party, again all actions may occur coincidentally.

Variations of the method embodied in FIG. 2, though not shown, may also exist. A request may be received by a reception processor (see FIG. 1, 108) configured to interface with at least one memory unit (see FIG. 1, 114), the memory unit (see FIG. 1, 114) storing at least one message application (see FIG. 1, 118) capable of receiving an authorized request 202 for creating a TC 220, the reception processor (see FIG. 1, 108) also configured to interface with at least one memory unit (see FIG. 1, 114) storing at least one account application (see FIG. 1, 120) capable of creating or authenticating at least one customer account associated with the request received, wherein the account application is capable of issuing at least one, time-limited authorized-client-requested, user token 212 capable of facilitating a request validation and of maintaining an end user session. A client may be a partner, associate, or approved party, of the owner, operator, or licensee of the system(s), method(s), and/or apparatus disclosed herein. A request may be received through an application programming interface from a site owned or controlled by an authorized client of the owner, operator, or licensee of the disclosed method, or an application programming interface supplied to a user by such client. Receiving a request 202 may be for a TC for a user or a third party, or for numerous other processing by or distributions from the system(s), method(s), and/or apparatus disclosed herein, such as but not limited to creating a customer account 210, activating, reloading, or redeeming a TC, inquiring on remaining value of an issued TC, voiding a transaction, customized formatting or imagery of the TC, or of a desired message or imagery to accompany the transmission of the TC, summary information of at least one order of a customer in a specified period, or gathering information about users, clients, purchases, or products. Determining request approval 214 may comprise a decision processor (see FIG. 1, 110) configured to interface with at least one memory unit (see FIG. 1, 114), the memory unit storing at least one evaluation application (see FIG. 1, 122) for verifying sufficient prepayment or account credit line for requested 216 for distributing a TC 218. The method also comprises interfacing with an accessible resource 224 encoded in a computer-readable medium, the accessible resource configured to interface with any processor or application comprising the method and to store any data, records, images, information, or the like as may be needed by any processor or application comprising the method. Distributing at least one approved TC 220 and/or at least one alternate message 206 by a response processor (see FIG. 1, 112) configured to interface with at least one memory unit (see FIG. 1, 114) storing at least one output application (see FIG. 1, 124) for distributing at least one approved TC 220 and/or at least one alternate message 206, may comprise the reception, decision, and response processors being capable of interfacing with each other for coincidentally receiving a user request 202, creating a customer account 210, issuing a user token 212, verifying prepayment 216 for the TC, determining request approval 214, creating a transaction credit account 218, and distributing at least one TC 220 and notification 222 of same, to at least one user or third party.

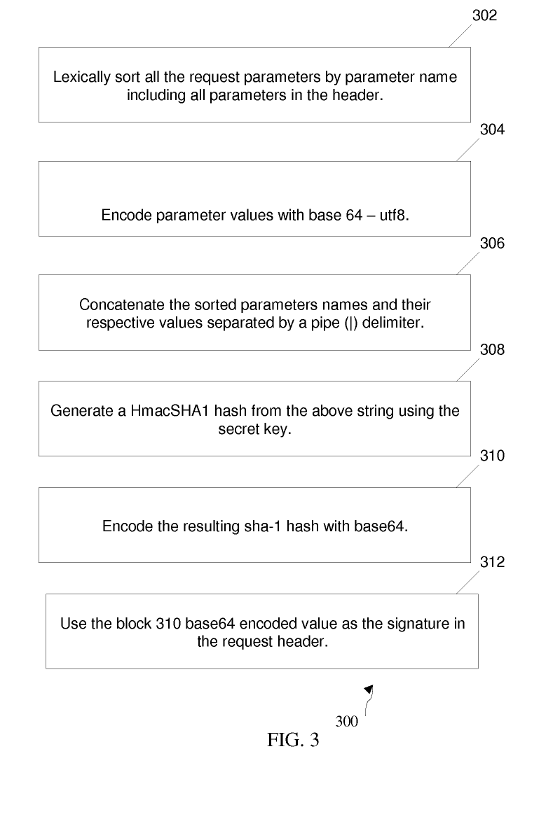

Turning now to FIG. 3, a flow chart for an embodiment of a procedure 300 for creating a message signature is disclosed. At block 302, lexically sort all the request parameters by parameter name including all parameters in the header (client_ref_id, timestamp, nonce, usertoken, encryption_type, user_ip). At block 304, encode parameter values with base 64-utf8. At block 306, concatenate the sorted parameters names and their respective values separated by a pipe (|) delimiter. At block 308, generate a HmacSHA1 hash from the above string using the secret key. At block 310, encode the resulting sha-1 hash with base64. At block 312, use the block 310 base64 encoded value as the signature in the request header.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented. The following numbered entries represent a non-exhaustive collection of exemplary embodiments of the instantly disclosed subject matter:

1. A system for providing a transaction credit, the system comprising:
a reception processor configured to receive a transaction credit request, wherein the request may be received through an application programming interface;
a decision processor configured to determine approval of the request;
a accessible resource encoded in a computer-readable medium configured to interface with the processors of the system; and
a response processor configured to distribute an approved transaction credit and/or an alternate message, wherein the reception, decision, and response processors are capable of interfacing with each other to coincidentally receive a user request, determine approval of the request, create a transaction credit account, and distribute a transaction credit to a user or third party.

2. The system of embodiment 1, wherein the reception processor is configured to receive the request from a third party communicating with the system through a communication network of a client to the system that is authorized to communicate with the system.

3. The system of embodiment 1 or 2, wherein the transaction credit request can be made via selection from a catalog of products available in the system accessible resource.

4. The system of embodiment 1 or 2, wherein the accessible resource has not previously contained information about the third party requesting the transaction credit.

5. The system of embodiment 1, wherein the response processor distributes the approved transaction credit as an email message or uniform resource locator (URL).

6. The system of embodiment 5, wherein the response processor distributing the email message of the approved transaction credit also generates and sends a notification to the transaction credit recipient's social media device.

7. The system of embodiment 1, wherein the response processor distributes the transaction credit for tangible delivery via output to a fabricator.

8. The system of embodiment 1, wherein the reception processor is configured to receive a request for customized formatting of the approved transaction credit and/or a supplementary message to the recipient of the transaction credit, the decision processor is configured to approve the request, and the response processor is configured to distribute customized formatting of the approved transaction credit and/or a supplementary message to the recipient of the transaction credit.

9. The system of embodiment 1, wherein the requested or distributed customized formatting of the transaction credit and/or a supplementary message may be retained in the accessible resource for future access by any processor of the system.

10. The system of embodiment 1, wherein a single request can be processed to distribute transaction credits for more than one recipient.

11. A method of providing a transaction credit, the method comprising:
receiving a transaction credit request by a reception processor, wherein the request may be received through an application programming interface;
determining whether to approve the request for transaction credit by a decision processor;
interfacing with an accessible resource encoded in a computer-readable medium; and
distributing an approved transaction credit and/or an alternate message by a response processor, wherein the reception, decision, and response processors are capable of interfacing with each other to coincidentally receive a user request, determine approval of the request, create a transaction credit account, and distribute a transaction credit to at least one user or third party.

12. The method of embodiment 11, wherein the reception processor is configured to receive the transaction credit request from a third party communicating with the system through a communication network of a client to the system that is authorized to communicate with the system.

13. The method of embodiment 11 or 12, wherein the accessible resource has not previously contained information about the third party requesting the transaction credit.

14. The method of embodiment 11, wherein response processor distributes the transaction credit as an email message or uniform resource locator (URL).

15. The method of embodiment 14, wherein the response processor distributing an email transmission of a transaction credit also generates and sends a notification transmission to the transaction credit recipient's social media device.

16. The method of embodiment 11, wherein the response processor distributes the transaction credit for delivery via output to a fabricator.

17. The method of embodiment 11, wherein the reception processor is configured to receive a request for customized formatting of the approved transaction credit and/or a supplementary message to the recipient of the transaction credit, the decision processor is configured to approve the request, and the response processor is configured to distribute customized formatting of the approved transaction credit and/or a supplementary message to the recipient of the transaction credit.

18. The method of embodiment 11, wherein a single request can be processed to distribute transaction credits for more than one recipient.

19. A computer-readable medium containing an encoded instruction corresponding to a method for providing a transaction credit, the method comprising:
receiving a transaction credit request by a reception processor, wherein the request may be received through an application programming interface;
determining whether to approve the request for transaction credit by a decision processor;
interfacing with an accessible resource encoded in a computer-readable medium; and
distributing an approved transaction credit and/or an alternate message by a response processor, wherein the reception, decision, and response processors are capable of interfacing with each other to coincidentally receive a user request, determine approval of the request, create transaction credit account, and distribute a transaction credit to at least one user or third party.

In addition, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

We claim:

1. A system for providing a transaction credit, the system comprising:
a reception processor configured to receive a transaction credit request, wherein the request may be received through an application programming interface;
a decision processor configured to determine approval of the request;
a accessible resource encoded in a computer-readable medium configured to interface with the processors of the system; and
a response processor configured to distribute an approved transaction credit and/or an alternate message,
wherein the reception, decision, and response processors are capable of interfacing with each other to coincidentally receive a user request, determine approval of the request, create a transaction credit account, and distribute a transaction credit to a user or third party.

2. The system of claim 1, wherein the reception processor is configured to receive the request from a third party communicating with the system through a communication network of a client to the system that is authorized to communicate with the system.

3. The system of claim 1, wherein the transaction credit request can be made via selection from a catalog of products available in the system accessible resource.

4. The system of claim 1, wherein the accessible resource has not previously contained information about the third party requesting the transaction credit.

5. The system of claim 1, wherein the response processor distributes the approved transaction credit as an email message or uniform resource locator (URL).

6. The system of claim 5, wherein the response processor distributing the email message of the approved transaction credit also generates and sends a notification to the transaction credit recipient's social media device.

7. The system of claim 1, wherein the response processor distributes the transaction credit for tangible delivery via output to a fabricator.

8. The system of claim 1, wherein the reception processor is configured to receive a request for customized formatting of the approved transaction credit and/or a supplementary message to the recipient of the transaction credit, the decision processor is configured to approve the request, and the response processor is configured to distribute customized formatting of the approved transaction credit and/or a supplementary message to the recipient of the transaction credit.

9. The system of claim 1, wherein the requested or distributed customized formatting of the transaction credit and/or a supplementary message may be retained in the accessible resource for future access by any processor of the system.

10. The system of claim 1, wherein a single request can be processed to distribute transaction credits for more than one recipient.

11. A method of providing a transaction credit, the method comprising:
receiving a transaction credit request by a reception processor, wherein the request may be received through an application programming interface;
determining whether to approve the request for transaction credit by a decision processor;
interfacing with an accessible resource encoded in a computer-readable medium; and
distributing an approved transaction credit and/or an alternate message by a response processor,
wherein the reception, decision, and response processors are capable of interfacing with each other to coincidentally receive a user request, determine approval of the request, create a transaction credit account, and distribute a transaction credit to at least one user or third party.

12. The method of claim 11, wherein the reception processor is configured to receive the transaction credit request from a third party communicating with the system through a communication network of a client to the system that is authorized to communicate with the system.

13. The method of claim 11, wherein the accessible resource has not previously contained information about the third party requesting the transaction credit.

14. The method of claim 12, wherein the accessible resource has not previously contained information about the third party requesting the transaction credit.

15. The method of claim 11, wherein response processor distributes the transaction credit as an email message or uniform resource locator (URL).

16. The method of claim 15, wherein the response processor distributing an email transmission of a transaction credit also generates and sends a notification transmission to the transaction credit recipient's social media device.

17. The method of claim 11, wherein the response processor distributes the transaction credit for delivery via output to a fabricator.

18. The method of claim 11, wherein the reception processor is configured to receive a request for customized formatting of the approved transaction credit and/or a supplementary message to the recipient of the transaction credit, the decision processor is configured to approve the request, and the response processor is configured to distribute customized formatting of the approved transaction credit and/or a supplementary message to the recipient of the transaction credit.

19. The method of claim 11, wherein a single request can be processed to distribute transaction credits for more than one recipient.

20. A computer-readable medium containing an encoded instruction corresponding to a method for providing a transaction credit, the method comprising:
receiving a transaction credit request by a reception processor, wherein the request may be received through an application programming interface;
determining whether to approve the request for transaction credit by a decision processor;
interfacing with an accessible resource encoded in a computer-readable medium; and
distributing an approved transaction credit and/or an alternate message by a response processor,
wherein the reception, decision, and response processors are capable of interfacing with each other to coincidentally receive a user request, determine approval of the request, create transaction credit account, and distribute a transaction credit to at least one user or third party.
